(19) United States
(12) Patent Application Publication
(10) Pub. No.: US 2012/0067821 A1
(43) Pub. Date: Mar. 22, 2012

(54) Filter Medium For Leukocyte Removal

(75) Inventors: Yung Chang, Tao-Yuan (TW); Ruoh-Chyu Ruaan, Taoyuan County (TW); Ging-Ho Hsiue, Tao-Yuan (TW)

(73) Assignee: CHUNG YUAN CHRISTIAN UNIVERSITY, Tao-Yuan (TW)

(21) Appl. No.: 13/095,976

(22) Filed: Apr. 28, 2011

Related U.S. Application Data
(60) Provisional application No. 61/383,556, filed on Sep. 16, 2010.

(51) Int. Cl. B01D 61/00; B05D 3/10; B01D 71/34; B01D 67/00; B01D 71/48; B01D 71/36

(52) U.S. Cl. 210/651; 210/490; 427/2.3

(57) ABSTRACT

The present invention discloses a filter medium for removing leukocytes from a leukocyte-containing sample, comprising: a substrate and a first polymer. The first polymer forms cross-linked networks or polymer brushes on the substrate and comprising charged groups or latent charged groups to control the electrical characteristic of the first polymer. The surface of the substrate formed with the first polymer possesses a specific charge distribution having charged domains and zwitterionic non-charged domains.

### BACKGROUND OF THE INVENTION

1. Field of the Invention

The present invention is generally related to a filter medium for leukocyte removal, and more particularly to a filter medium for leukocyte removal and a method for selectively removing leukocytes without causing blood coagulation.

2. Description of the Prior Art

During blood transfusion, it is found that leukocytes will cause various responses, such as immune response in the recipient's blood. Thus, it has been regulated in many countries for any blood transfusion regardless of erythrocyte or platelet transfusion, the concentration of leukocytes in the blood sample should reduce to below a certain level in order to prevent the above mentioned blood transfusion responses. Only for those who need leukocytes, leukocyte concentrate is in used. Furthermore, the merits of leukocyte removal also include preventing virus infection through blood transfusion, reducing the possibility of fever response, reducing the probability of void platelet transfusion, preventing immunity from decreasing, and so forth.

Generally, leukocytes can be removed by a filter comprising a fiber material or the like. The mechanism for filtering leukocytes has not been known clearly yet. Mostly, the size and depth of the filter material are considered important.

In order to prevent platelets from adhering to a material, a hydrophilic monomer can be grafted to the surface of the material. However, by coating a hydrophilic polymer on the surface of the filter material coated with or having a hydrophilic monomer graft-polymerized on the surface of the filter material, the surface becomes less adhesive not only to platelets but also to leukocytes. On the other hand, it is known that the positively charged surface of the filter material becomes well adhesive to both platelets and leukocytes which have a negative charge. Thus, a fiber material or a filter with a sponge structure is widely used as the filter medium for removing leukocytes by adsorption. In addition, the fiber material is often surface modified to improve its selectivity. A variety of modifications on the fiber material are reported.

U.S. Pat. No. 4,936,998 disclosed a filter medium for selectively removing leukocytes to efficiently remove leukocytes while holding down the loss of platelets to a minimum by a fiber having nonionic hydrophilic groups and nitrogen-containing basic functional groups in its peripheral surface portion and having a basic nitrogen atom content of from 0.2 to 4.0% by weight in the surface portion. It indicates that arbitrarily having the surface of a filter medium be positively charged or negatively charged is undesired.

U.S. Pat. No. 4,880,548 disclosed a device for the depletion of the leukocyte content in a platelet concentrate, preferably comprising a modified porous, fibrous medium with a critical wetting surface tension of at least about 90 dynes/cm.

However, while the filter medium according to the prior art is in use, anticoagulants are required to be added into the suspension, or concentrate to be filter. Such a filter medium is unavoidable to cause blood clotting. To solve such a problem, a new filter medium for leukocyte removal is still needed not only to efficiently remove leukocytes but also to prevent blood clotting.

### SUMMARY OF THE INVENTION

In accordance with the present invention, a new filter medium for leukocyte removal and a method for selectively removing leukocytes are provided.

The operation principle of leukocyte removal by the filter medium according to the present invention is to use a plurality of positively charged groups and negatively charged groups to control the electrical property of the surface of the filter medium according to the invention so as to remove leukocytes from a blood sample without causing blood coagulation. The above mentioned positively charged groups and negatively charged groups can be derived from (1) a compound comprising zwitterionic groups and a compound comprising positively charged groups, (2) a compound comprising zwitterionic groups and a compound comprising negatively charged groups, or (3) a compound comprising positively charged groups and a compound comprising negatively charged groups.

One object of the present invention is to provide a filter medium for leukocyte removal through the ion-pair mechanism without causing blood coagulation.

Another object of the present invention is to provide a filter medium for leukocyte removal and a filtering method applicable to (1) a leukocyte/platelet containing sample, (2) a leukocyte/erythrocyte containing sample, and (3) a whole blood sample.

One characteristic of the present invention discloses a filter medium for leukocyte removal, filtering leukocytes from a leukocyte-containing sample. The filter medium comprises: a substrate and a first polymer. The first polymer forms cross-linked networks or polymer brushes on the substrate and comprises charged groups or latent charged groups to control the electrical characteristic of the first polymer. The surface of the substrate formed with the first polymer possesses a specific charge distribution having charged domains and non-charged domains to thereby filter leukocytes. The first polymer comprises the first polymer comprises a plurality of positively charged groups and a plurality of negatively charged groups. The positively charged groups and the negatively charged groups are derived from (1) a compound comprising zwitterionic groups and a compound comprising positively charged groups, (2) a compound comprising zwitterionic groups and a compound comprising negatively charged groups, or (3) a compound comprising positively charged groups and a compound comprising negatively charged groups.

In one embodiment, when the surface of the substrate formed with the first polymer is positively charged, the molar ratio of the positively charged groups to the negatively charged groups is between 50.5:49.5 and 70:30. In another embodiment, when the surface of the substrate formed with the first polymer is negatively charged, the molar ratio of the positively charged groups to the negatively charged groups is between 49.5:50.5 and 40:60. In another embodiment, when the surface of the substrate formed with the first polymer is charge balanced (uncharged), the substrate comprises a plurality of pores having an average pore diameter of 1˜8 μm.

The above mentioned zwitterionic groups are derived from the group consisting of the following:

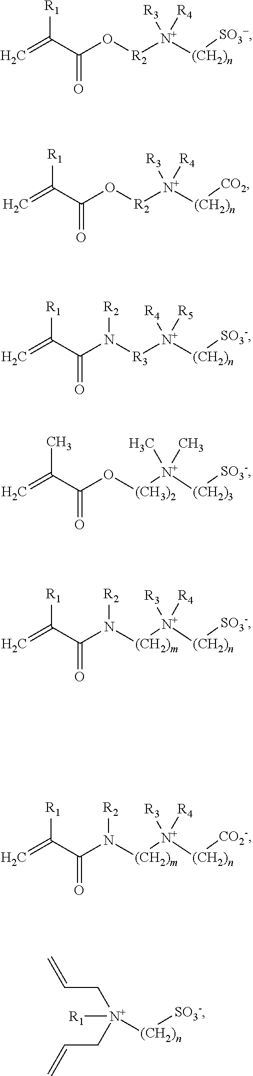

N-(2-aminoethyl)carbamoyl propanoic acid having the following general equation:

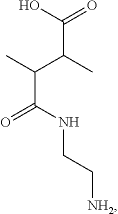

N-(3-aminopropyl)carbamoyl propanoic acid having the following general equation:

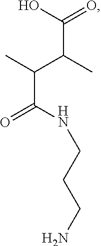

N—(N′,N′-dimethyl-2-aminoethyl)carbamoyl propanoic acid having the following general equation:

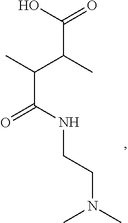

and N—(N′,N′-dimethyl-3-aminopropyl)carbamoyl propanoic acid having the following general equation:

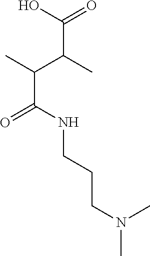

where R₁, R₂, R₃, R₄, and R₅ are alkyl groups and n, m are integers of 2˜5.

The above mentioned the positively charged groups are derived from the group consisting of the following:

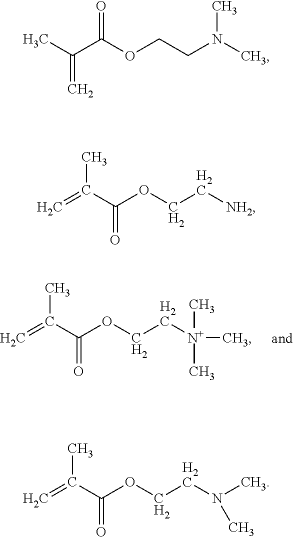

The above mentioned the negatively charged groups are derived from the group consisting of the following:

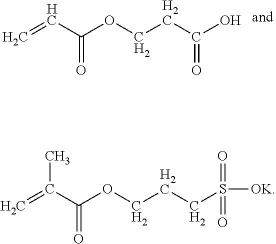

In one embodiment, the substrate is a membrane having a bi-continuous structure or a fibrous structure. The substrate can be made of a second polymer selected from the group consisting of the following: Polypropylene (PP), polytetrafluoroethylene (PTFE), polystyrene (PS), polyethylene terephthalate (PET), polyester, polyvinylidene fluoride (PVDF), fluoropolymer, nowoven fiber, and polyurethane (PU). In one embodiment, the substrate is a membrane having a bi-continuous structure and the pore diameter of the membrane is in a range of 1˜8 μm. In another embodiment, the substrate is a membrane having a fibrous structure, the pore diameter of the membrane is in a range of 1˜8 μm, and the average fiber diameter is in a range of 1˜3 μm.

Another characteristic of the present invention discloses a method for removing leukocytes from a leukocyte-containing sample. The method comprises the following steps: providing a substrate; coating a first polymer on the substrate wherein the first polymer forms cross-linked networks or polymer brushes on the substrate and comprises charged groups or latent charged groups to control the electrical characteristic of the first polymer such that the surface of the substrate formed with the first polymer possesses a specific charge distribution having charged domains and non-charged domains; and having the leukocyte-containing sample pass through the substrate to obtain a filtered solution. The method of removing leukocytes from the leukocyte-containing sample uses the specific charge distribution having charged domains and zwitterionic non-charged domains to filter leukocytes. The first polymer has the same characteristics as that in the above mentioned filter medium.

In one embodiment, the specific charge distribution is determined by the allocation and the concentration of the charged groups or the latent charged groups.

Furthermore, one characteristic of the present invention discloses a method for manufacturing a filter medium to remove leukocytes. The method comprises: providing a substrate; performing surface treatment to the substrate; and forming a first polymer on the surface of the substrate by thermal induced radical polymerization or surface initiated atom transfer radical polymerization; wherein the first polymer is formed by polymerization of a monomer containing zwitterionic groups and a monomer containing positively charged groups, polymerization of a monomer containing zwitterionic groups and a monomer containing negatively charged groups, or polymerization of a monomer containing positively charged groups and a monomer containing negatively charged groups. The surface treatment is preferably ozone exposure treatment or treatment including ozone exposure and bromide activation.

In conclusion, the present invention discloses a filter medium for leukocyte removal, a method for manufacturing thereof, and a method for selectively removing leukocytes without causing blood coagulation. The charge distribution of the surface of the filter medium, the hydrophilic and hydrophobic characteristics of the surface of the filter medium, and the microstructures of the filter medium are utilized to achieve the purpose of filtering leukocytes without causing blood coagulation.

### BRIEF DESCRIPTION OF THE DRAWINGS

FIG. 1 shows a schematic diagram illustrating the cross-linked networks of the first polymer on the surface of the substrate where (a) shows the zwitterionic groups and the negatively charged groups mix together; (b) shows the zwitterionic groups and the positively charged groups mix together; (c) shows the fewer positively charged groups and the more negatively charged groups mix together; and (d) shows the more positively charged groups and the fewer negatively charged groups mix together according to one embodiment of the invention;

FIG. 2 shows a schematic diagram illustrating the polymer brushes of the first polymer on the surface of the substrate where (a) shows the zwitterionic groups and the negatively charged groups mix together; (b) shows the zwitterionic groups and the positively charged groups mix together; (c) shows the fewer positively charged groups and the more negatively charged groups mix together; and (d) shows the more positively charged groups and the fewer negatively charged groups mix together according to one embodiment of the invention;

FIGS. 3 (a) and (b) show schematic diagrams where (a) shows the surface of substrate is activated by ozone treatment and then the polymer brushes of the first polymer in FIG. 2 can be formed on the surface by thermal induced radical polymerization; and (b) shows in another example the surface of substrate is treated by ozone treatment and bromide activation and then the polymer brushes of the first polymer in FIG. 2 can be formed on the surface by surface-initiated atomic transfer radical polymerization;

FIGS. 4 (a)˜(d) show schematic diagrams illustrating the polymer brushes of the first polymer can be formed on the substrate through a hydrophobic moiety where 201 indicates a zwitterionic group, 202 indicates a positively charged group, 203 indicates a negatively charged group, and 204 indicates a hydrophobic segment;

FIG. 5 shows a schematic diagram illustrating the structure of the substrate 101 according to the first embodiment of the invention;

FIGS. 6(a) and 6(b) show perspective-view and cross-sectional schematic diagrams illustrating that the zwitterionic groups 201 and the positively charged groups 202 are distributed on the substrate 101;

FIGS. 7(a) and 7(b) show perspective-view and cross-sectional schematic diagrams illustrating that the zwitterionic groups 201 and the negatively charged groups 203 are distributed on the substrate 101;

FIG. 8(a) shows a perspective-view schematic diagram illustrating that the positively charged groups 202 and the negatively charged groups 203 are distributed on the substrate 101;

FIGS. 8(b)˜(d) show cross-sectional schematic diagrams illustrating that the positively charged groups 202 and the negatively charged groups 203 are distributed on the substrate 101 where (b) shows charge balanced, (c) shows positively charged, and (d) shows negatively charged;

FIG. 9 shows scanning electron microscopic images illustrating the platelet adhesion test of the filter medium having different molar ratios of the negatively charged groups (S) to the positively charged groups (T) where (a) S0T10 (b) S3T7 (c) S5T5 (d)S7T3 (e) S10T0 according to the example 2 of the present invention;

FIG. 10 shows laser scanning confocal microscopic images illustrating the erythrocyte adhesion test of the filter medium having different molar ratios of the negatively charged groups (S) to the positively charged groups (T) where (a) S0T10 (b) S3T7 (c) S5T5 (d)S7T3 (e) S10T0 according to the example 3 of the present invention;

FIG. 11 shows laser scanning confocal microscopic images illustrating the whole blood adhesion tests of the filter media with positive-charge rich surfaces where (a1)˜(a5) and (b1)˜(b5) show the tests for the whole blood without and with Ca²⁺ ions, respectively; and (a1) and (b1) are tested for S: 0%/T: 100%; (a2) and (b2) are for S: 10%/T: 90%; (a3) and (b3) are for S: 20%/T: 80%; (a4) and (b4) are for S: 30%/T: 70%; and (a5) and (b5) are for S: 40%/T: 60%;

FIG. 12 shows laser scanning confocal microscopic images illustrating the whole blood adhesion tests of the filter media with neutral surfaces where (a1) and (b1) show the tests for the whole blood without and with Ca²⁺ ions on the filter medium of S: 50%/T: 50%; and

FIG. 13 shows laser scanning confocal microscopic images illustrating the whole blood adhesion tests of the filter media with negative-charge rich surfaces where (a1)-(a5) and (b1)-(b5) show the tests for the whole blood without and with Ca²⁺ ions, respectively; and (a1) and (b1) are tested for S: 100%/0/T: 10° A; (a2) and (b2) are for S: 90%/T: 10%; (a3) and (b3) are for S: 80%/T: 20%; (a4) and (b4) are for S: 70%/T: 30%; and (a5) and (b5) are for S: 60%/T: 40%.

### DESCRIPTION OF THE PREFERRED EMBODIMENTS

What is probed into the invention is a filter medium for leukocyte removal, a method for manufacturing thereof, and a method for selectively removing leukocytes without causing blood coagulation. Detail descriptions of the structure and elements will be provided in the following in order to make the invention thoroughly understood. Obviously, the application of the invention is not confined to specific details familiar to those who are skilled in the art. On the other hand, the common structures and elements that are known to everyone are not described in details to avoid unnecessary limits of the invention. Some preferred embodiments of the present invention will now be described in greater detail in the following. However, it should be recognized that the present invention can be practiced in a wide range of other embodiments besides those explicitly described, that is, this invention can also be applied extensively to other embodiments, and the scope of the present invention is expressly not limited except as specified in the accompanying claims.

According to the filter medium of the invention, the charge distribution of the surface of the filter medium, the hydrophilic and hydrophobic characteristics of the surface of the filter medium, and the microstructures of the filter medium are utilized to adjust the selectivity of leukocytes corresponding to platelets and erythrocytes so as to achieve the purpose of efficiently filtering leukocytes without causing blood coagulation. The design of the charge distribution of the surface of the filter medium is to graft a specific polymer on the surface of a substrate (a membrane) to have the surface comprise a plurality of charged domains and a plurality of zwitterionic non-charged domains so as to form a specific charge distribution. The above mentioned “zwitterionic non-charged domain” means that the domain is uncharged but microscopically comprises charge-balanced positively-charged and negatively-charged sub-domains so that the zwitterionic non-charged domain has zwitterionic-like property. Besides, the hydrophilic and hydrophobic characteristics of the surface of the filter medium can be adjusted by selection of various types of substrates and selection of the polymer formed on the surface of the substrate (or modifying the surface of the substrate). The microstructures of the filter medium can be adjusted by selection of various types of substrates.

A first embodiment of the present invention discloses a filter medium for removing leukocytes from a leukocyte-containing sample. The leukocyte-containing sample includes for example (1) a leukocyte/platelet containing sample, (2) a leukocyte/erythrocyte containing sample, and (3) a whole blood sample. The above mentioned sample can be either suspension or concentrate. The filter medium comprises a substrate and a first polymer. The first polymer forms cross-linked networks or polymer brushes on the substrate and comprises charged groups or latent charged groups to control the electrical characteristic of the first polymer. The surface of the substrate formed with the first polymer possesses a specific charge distribution having charged domains and zwitterionic non-charged domains to so that leukocytes are removed from the leukocyte-containing sample without causing coagulation. The latent charged group is an uncharged group but may become charged while experiencing an external force. The charged domain is defined as the area on the surface of the filter medium containing positively charged groups or negatively charged groups to thereby totally appear to be charged in the domain. The zwitterionic non-charged domain is defined as the area on the surface of the filter medium containing positively charged groups, negatively charged groups, or zwitterionic groups but appearing to be electrically neutral (charged balanced).

The above mentioned charged domain, for example, comprises positively charged groups and negatively charged groups. The zwitterionic non-charged domain, for example, comprises zwitterionic groups or pseudo zwitterionic groups or comprises positively charged groups and negatively charged groups with a 1:1 molar ratio so that the zwitterionic non-charged domain is an uncharged (charge balanced) domain. The zwitterionic non-charged domain does not mean the domain containing uncharged groups only. Certainly, the charged domain and the zwitterionic non-charged domain can also include non-charged groups. Thus, the first polymer comprises a plurality of positively charged groups and a plurality of negatively charged groups. The positively charged groups and the negatively charged groups are derived from (1) a compound comprising zwitterionic groups and a compound comprising positively charged groups, (2) a compound comprising zwitterionic groups and a compound comprising negatively charged groups, or (3) a compound comprising positively charged groups and a compound comprising negatively charged groups.

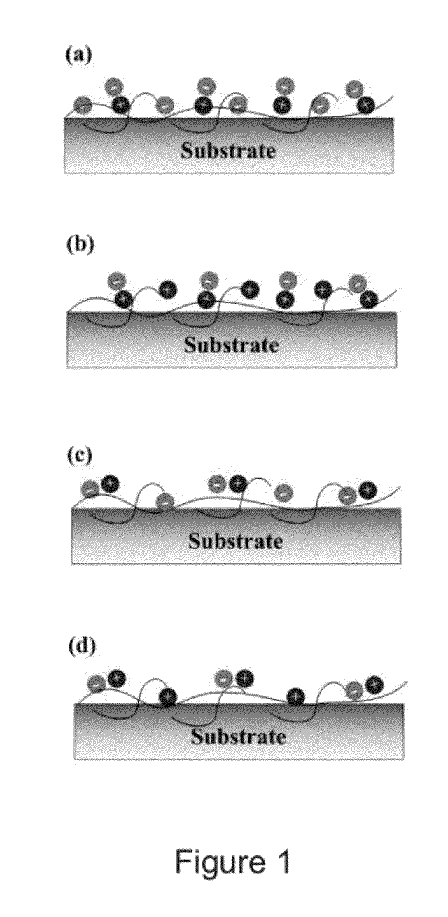

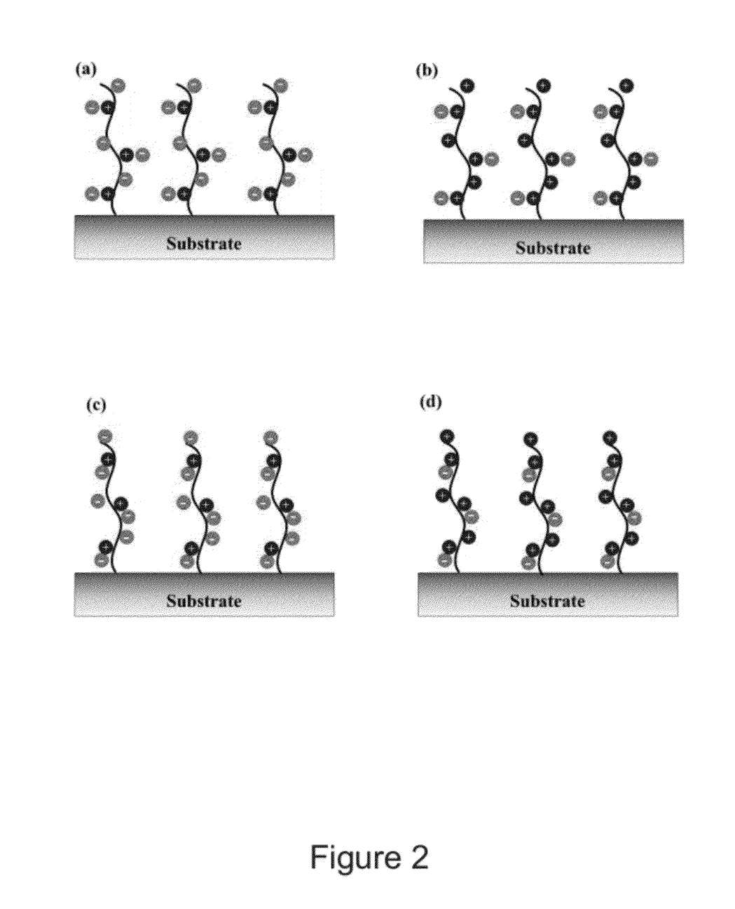

Specifically, as one example, a monomer containing zwitterionic groups and a monomer containing positively charged groups are graft-polymerized on the surface of the substrate. FIG. 1 shows a schematic diagram illustrating the cross-linked networks of the first polymer on the surface of the substrate where (a) shows the zwitterionic groups and the negatively charged groups mix together; (b) shows the zwitterionic groups and the positively charged groups mix together; (c) shows the fewer positively charged groups and the more negatively charged groups mix together; and (d) shows the more positively charged groups and the fewer negatively charged groups mix together according to one embodiment of the invention. The graft-polymerization is carried out by firstly forming radicals induced by plasma and then polymerizing. In another embodiment, FIG. 2 shows a schematic diagram illustrating the polymer brushes of the first polymer on the surface of the substrate where (a) shows the zwitterionic groups and the negatively charged groups mix together; (b) shows the zwitterionic groups and the positively charged groups mix together; (c) shows the fewer positively charged groups and the more negatively charged groups mix together; and (d) shows the more positively charged groups and the fewer negatively charged groups mix together.

The diameter of leukocytes in blood is about 6˜20 μm, that of erythrocytes is about 7˜8 μm, and that of platelets is about 3˜4 μm. Thus, nonwoven fabric is widely employed to filter leukocytes by adsorption. In addition, a filter material may be surface-modified to improve its hydrophilicity or to possess surface charge to increase leukocyte retention amount. However, it is known that when blood is contacted with a material having a surface with negative charges, blood coagulation factor XII in the blood is activated to thereby cause coagulation during filtering leukocytes. Therefore, the invention utilizes the ion-pair mechanism to filter (separate) leukocytes without causing coagulation. The ion-pair mechanism means that positively charged groups, negatively charged groups, zwitterionic groups, and pseudo zwitterionic groups are used to form a specific charge distribution on the surface of the substrate to thereby achieve the purpose of filtering leukocytes without causing coagulation.

In one embodiment, when the surface of the substrate formed with the first polymer is positively charged, the molar ratio of the positively charged groups to the negatively charged groups is between 50.5:49.5 and 70:30. In another embodiment, when the surface of the substrate formed with the first polymer is negatively charged, the molar ratio of the positively charged groups to the negatively charged groups is between 49.5:50.5 and 40:60. In another embodiment, when the surface of the substrate formed with the first polymer is charge balanced (uncharged), the substrate comprises a plurality of pores having an average pore diameter of 1˜8 μm. These pores are used to filter leukocytes and the filter medium of the invention does not cause coagulation.

The above mentioned zwitterionic groups are derived from the group consisting of the following:

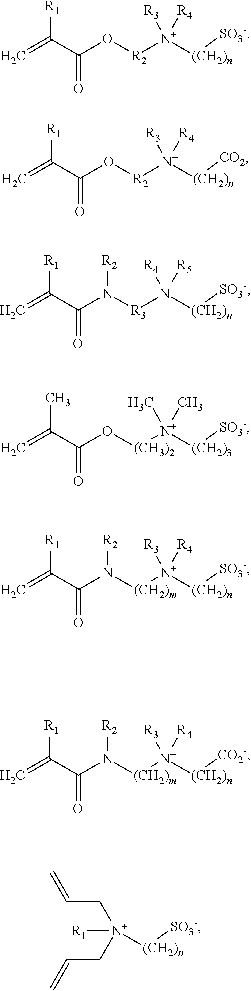

N-(2-aminoethyl)carbamoyl propanoic acid having the following general equation:

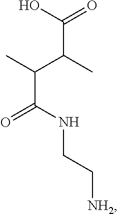

N-(3-aminopropyl)carbamoyl propanoic acid having the following general equation:

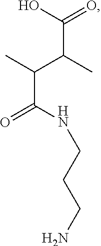

N—(N′,N′-dimethyl-2-aminoethyl)carbamoyl propanoic acid having the following general equation:

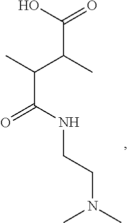

and N—(N′,N′-dimethyl-3-aminopropyl)carbamoyl propanoic acid having the following general equation:

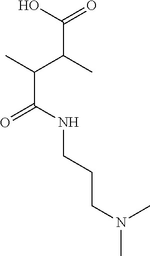

where R₁, R₂, R₃, R₄, and R₅ are alkyl groups and n, m are integers of 2˜5.

The above mentioned the positively charged groups are derived from the group consisting of the following:

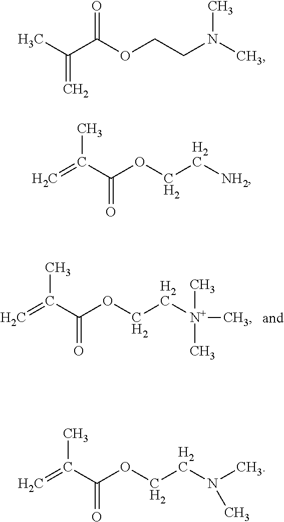

The above mentioned the negatively charged groups are derived from the group consisting of the following:

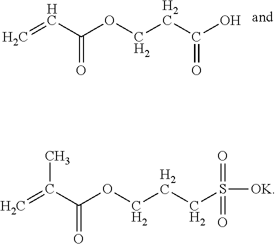

In one embodiment, the substrate is a membrane having a bi-continuous structure or a fibrous structure. The substrate can be made of a second polymer selected from the group consisting of the following: Polypropylene (PP), polytetrafluoroethylene (PTFE), polystyrene (PS), polyethylene terephthalate (PET), polyester, polyvinylidene fluoride (PVDF), fluoropolymer, nowoven fiber, and polyurethane (PU). In one embodiment, the substrate is a membrane having a bi-continuous structure and the pore diameter of the membrane is in a range of 1˜8 μm. In another embodiment, the substrate is a membrane having a fibrous structure, the pore diameter of the membrane is in a range of 1˜8 μm, and the average fiber diameter is in a range of 1˜3 μm.

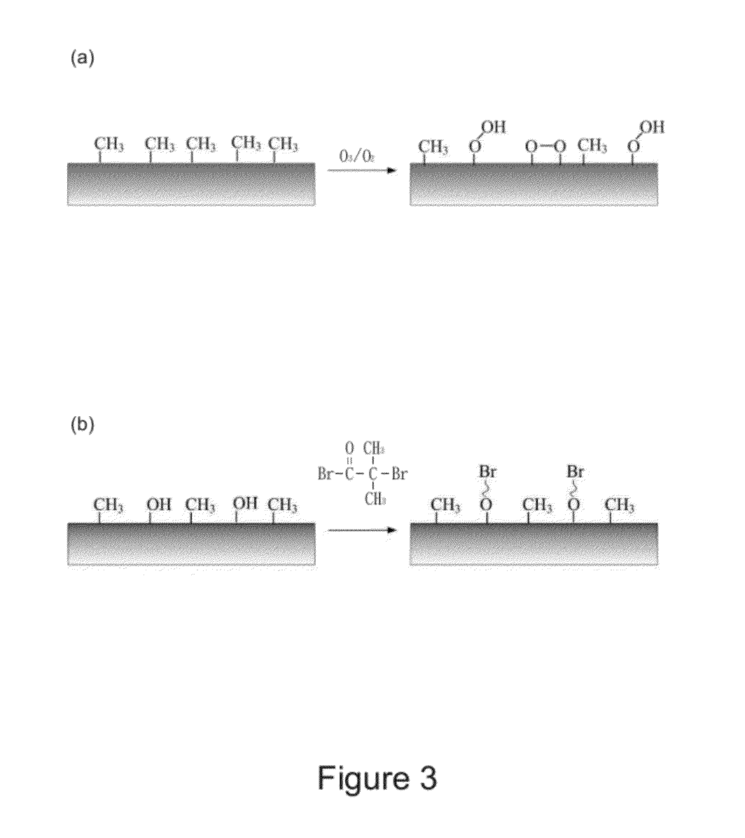

A second embodiment of the present invention discloses a method for manufacturing a filter medium to remove leukocytes. The method comprises: providing a substrate; performing surface treatment to the substrate; and forming a first polymer on the surface of the substrate by thermal induced radical polymerization or surface initiated atom transfer radical polymerization; wherein the first polymer is formed by polymerization of a monomer containing zwitterionic groups and a monomer containing positively charged groups, polymerization of a monomer containing zwitterionic groups and a monomer containing negatively charged groups, or polymerization of a monomer containing positively charged groups and a monomer containing negatively charged groups. The surface treatment is preferably ozone exposure treatment or treatment including ozone exposure and bromide activation. FIG. 3(a) shows the surface of substrate is activated by ozone treatment and then the polymer brushes of the first polymer in FIG. 2 can be formed on the surface by thermal induced radical polymerization. FIG. 3(b) shows in another example the surface of substrate is treated by ozone treatment and bromide activation and then the polymer brushes of the first polymer in FIG. 2 can be formed on the surface by surface-initiated atomic transfer radical polymerization.

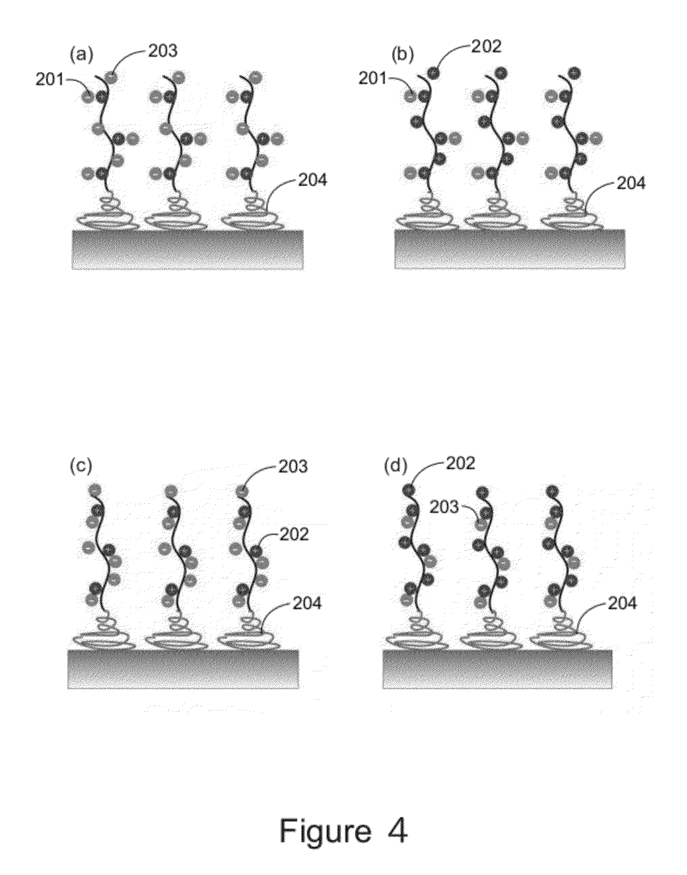

On the other hand, the first polymer is formed on the surface of the substrate through hydrophobic moieties, as shown in Figs. (a)˜(d). FIGS. 4(a)˜(d) show schematic diagrams illustrating the polymer brushes of the first polymer can be formed on the substrate through a hydrophobic moiety where 201 indicates a zwitterionic group, 202 indicates a positively charged group, 203 indicates a negatively charged group, and 204 indicates a hydrophobic segment. The groups 201˜203 can be the same as the above examples for the zwitterionic group, positively charged group, and negatively charged group. The hydrophobic moiety is, for example, a segment containing aromatic groups or aliphatic groups. In another example, the first polymer is an altered, random, or block copolymer containing zwitterionic or ionic groups (A) and hydrophobic segments (B) having, for example, a ABAB . . . , AABBAAAB . . . , or AAAAABBB sequence. Specifically, the examples of the first polymer containing A and B are

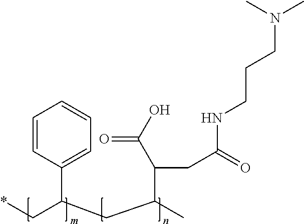

where A is 3-(dimethylamino)-1-propylamine derivative and B is poly(maleic anhydride-alt-1-octadecene),

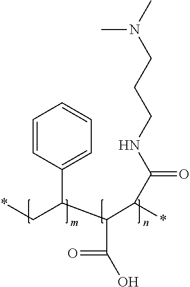

where A is 3-(dimethylamino)-1-propylamine derivative and B is poly(styrene-co-maleic anhydride), and

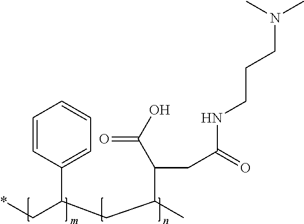

where A is 3-(dimethylamino)-1-propylamine derivative and B is poly(styrene-graft-maleic anhydride).

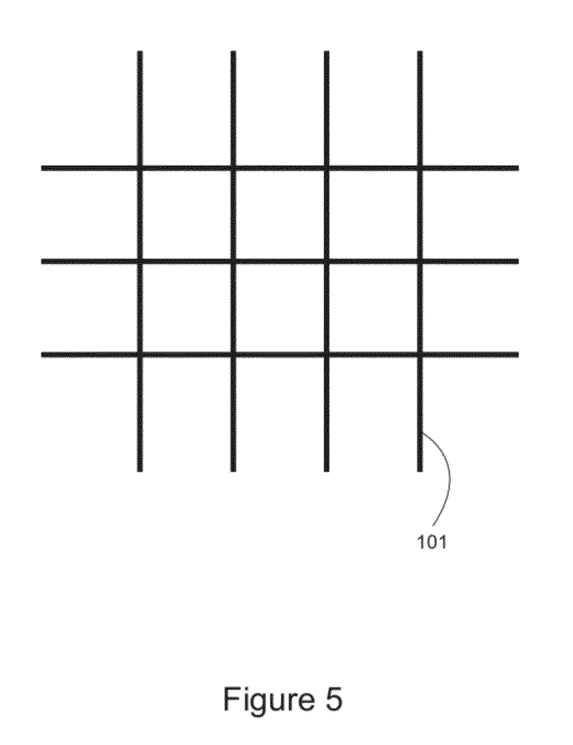

FIG. 5 shows an example of the structure of the substrate 101 according to one embodiment of the invention. The substrate has a fibrous structure, the pore diameter is about 1˜8 μm, and the average fiber diameter is about 1˜3 μm. The method of grafting the zwitterionic groups, the negatively charged groups, or positively charged groups onto the substrate includes for example radical polymerization, atomic transfer radical polymerization (ATRP), and etc.

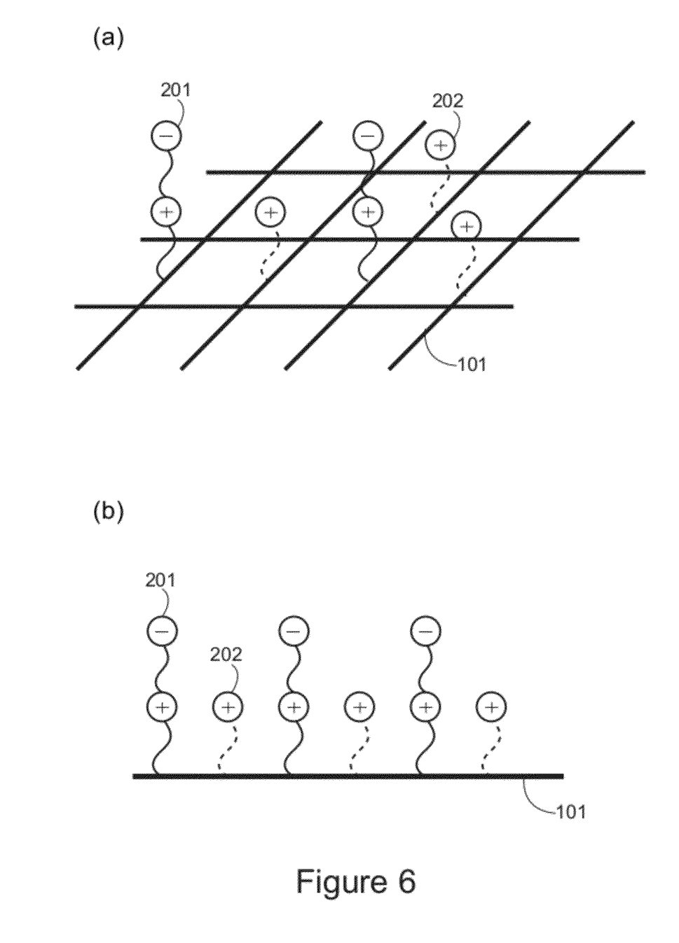

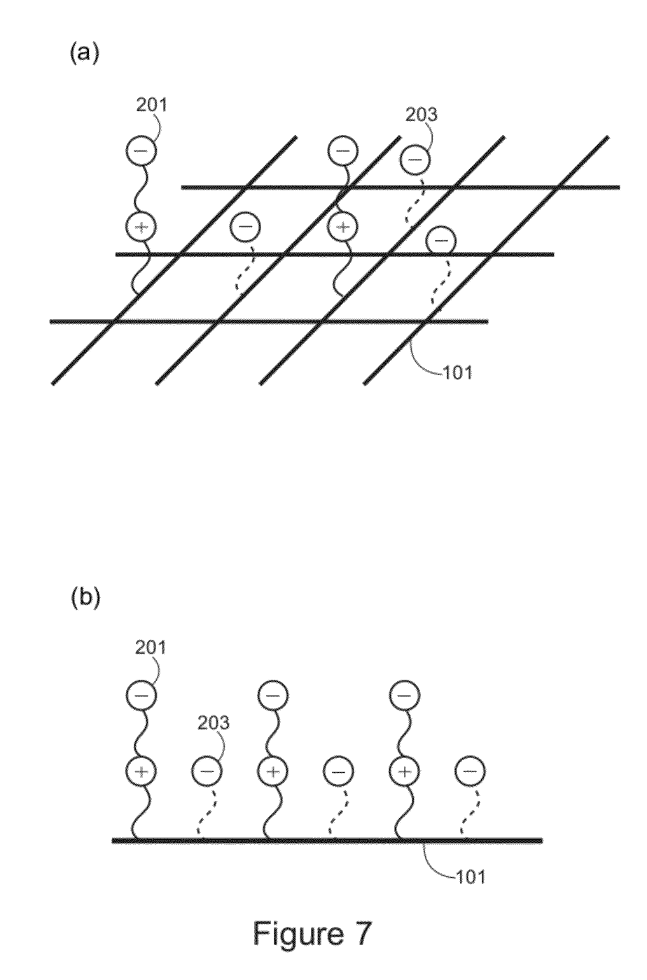

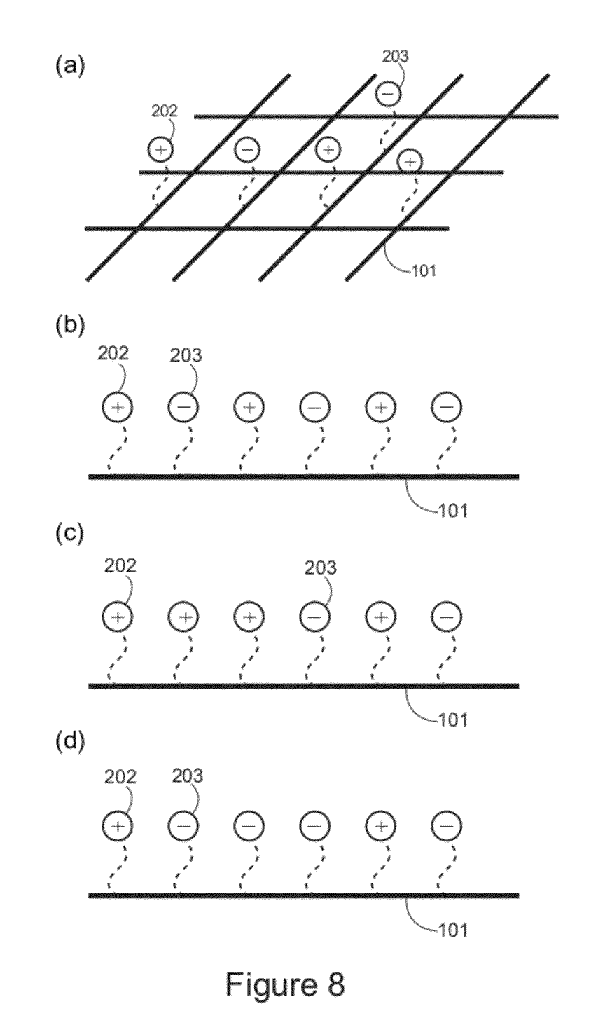

FIGS. 6(a) and 6(b) show perspective-view and cross-sectional schematic diagrams illustrating that the zwitterionic groups 201 and the positively charged groups 202 are distributed on the substrate 101. FIGS. 7(a) and 7(b) show perspective-view and cross-sectional schematic diagrams illustrating that the zwitterionic groups 201 and the negatively charged groups 203 are distributed on the substrate 101. F FIG. 8(a) shows a perspective-view schematic diagram illustrating that the positively charged groups 202 and the negatively charged groups 203 are distributed on the substrate 101. FIGS. 8(b)˜(d) show cross-sectional schematic diagrams illustrating that the positively charged groups 202 and the negatively charged groups 203 are distributed on the substrate 101 where (b) shows charge balanced, (c) shows positively charged, and (d) shows negatively charged. Thus, the surface of the substrate can be positively or negatively charged or neutral (charge balanced). When the surface of the substrate possesses a different electrical property, the separation mechanism varies.

A third embodiment of the present invention discloses a method for removing leukocytes from a leukocyte-containing sample. The method comprises the following steps: providing a substrate; coating a first polymer on the substrate wherein the first polymer forms cross-linked networks or polymer brushes on the substrate and comprises charged groups or latent charged groups to control the electrical characteristic of the first polymer such that the surface of the substrate formed with the first polymer possesses a specific charge distribution having charged domains and non-charged domains; and having the leukocyte-containing sample pass through the substrate to obtain a filtered solution. The method of removing leukocytes from the leukocyte-containing sample uses the specific charge distribution having charged domains and zwitterionic non-charged domains to filter leukocytes. The first polymer has the same characteristics as that in the above mentioned filter medium. The above mentioned charged domain, for example, comprises positively charged groups and negatively charged groups. The zwitterionic non-charged domain, for example, comprises zwitterionic groups or pseudo zwitterionic groups or comprises positively charged groups and negatively charged groups with a 1:1 molar ratio.

The leukocyte-containing sample, for example, can be (1) a leukocyte/platelet containing sample, (2) a leukocyte/erythrocyte containing sample, or (3) a whole blood sample. The sample can be suspension or concentrate.

The following examples are used to further illustrate the filter medium of the invention and the effects thereof but the invention is not limited to these examples.

### Example 1

### Preparation of the First Polymer

3-Sulfopropyl methacrylate potassium salt (SA; negatively charged groups; purchased from Aldrich Co.; MW=246.33), [2-(Methacryloyloxy)ethyl]-trimethylammonium chloride solution (TM; positively charged groups; purchased from Aldrich Co.; MW=207.7), and N-Isopropylacrylamide (NIPAAm; purchased from ACROS; MW=113.16) with a specific ratio shown in Table I are blended thoroughly and then a cross linker (N,N′-methylenebisacryamide (MBAA); 10 wt %) is added into the mixture. After completely mixing, the initiators APS (ammonium persulfate) and TEMED (1 wt %) (N,N,N′,N′ tetramethylethylenediamine) are poured into the mixture solution and radical polymerization is carried out at 25° C. to form the first polymer. The reaction time is 5 hours to ensure completely reacted.

TABLE I
Molar ratio of SA to TM

| | |
|---|---|
| Reaction ratios of | Characterization of the |
| comonomers (mol %) | first polymer |

| Sample ID | SA | TM | X_{SA} | X_{TM} |
|---|---|---|---|---|
| S10T0 | 100 | 0 | 1 | 0 |
| S7T3 | 70 | 30 | 0.74 | 0.26 |
| S5T5 | 50 | 50 | 0.51 | 0.49 |
| S3T7 | 30 | 70 | 0.29 | 0.71 |
| S0T10 | 0 | 100 | 0 | 1 |

From the result shown in Table I, the molar ratio of SA to TM in the first polymer is almost the same as the molar ratio of mixed comonomers for polymerization.

### Example 2

### Platelet Adhesion Test for the First Polymer

The platelet adhesion test of the first polymer is carried out. The previously prepared first polymer forms into a plurality of hydrogel disks and the platelet adhesion process is activated by calcium ions. The hydrogel disks of 0.785 cm² surface area were placed in individual wells of a 24-well tissue culture plate and each well was equilibrated with 1000 mL of phosphate buffered solution (PBS) for 180 min at 37□. Blood was obtained from a healthy human volunteer. Platelet rich plasma (PRP) containing about 1×10⁵ blood cells/mL was prepared by centrifugation of the blood at 20 Hz (1200 rpm) for 10 min. The platelet concentration was determined by a microscopy (NIKON TS 100F). A 1000 ml of the platelet suspension plasma was placed on the hydrogel surface in each well of the tissue culture plate and incubated for 120 min at 37□. After the hydrogel disks were rinsed twice with 1000 mL of PBS, they were immersed into 2.5% glutaraldehyde of PBS for 48 hr at 4□ to fix the adhered platelets and adsorbed proteins, then rinsed 2 times with 1000 mL of PBS and gradient-dried with ethanol in 95% v/v PBS, 85% v/v PBS, 75% v/v PBS, 50% v/v PBS, 25% v/v PBS, 5% v/v PBS, and 0% v/v PBS for 5 min in each step and dried in air. Finally, the samples were sputter-coated with gold prior to observation under JEOL JSM-5410 SEM operating at 7 keV. The number of adhering platelets on the hydrogels was counted from SEM images at a 500 magnification from five different places on the same hydrogel disks. The process was repeated using three independent hydrogel disks (n=15 in total).

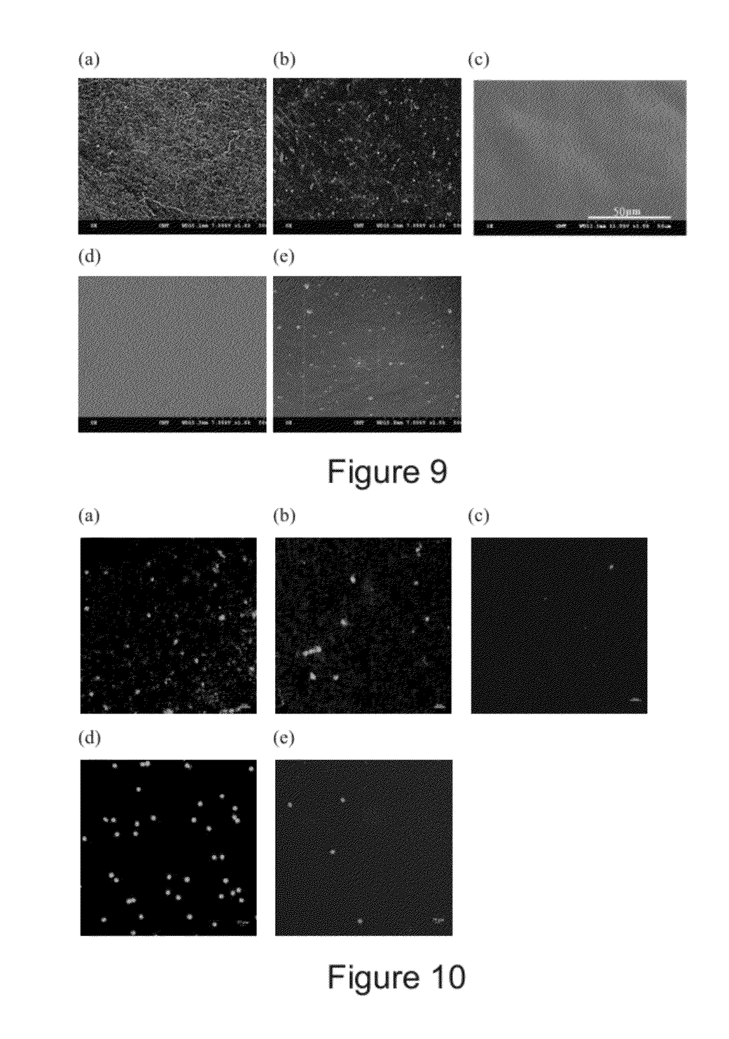

FIG. 9 shows scanning electron microscopic images illustrating the platelet adhesion test of the filter medium having different molar ratios of the negatively charged groups (S) to the positively charged groups (T) where (a)S0T10, (b)S3T7, (c)S5T5, (d)S7T3, and (e)S10T0 according to the example 2 of the present invention. As shown in FIG. 9, in (a)S0T10 and (b)S3T7, there are a large amount of platelets adhered. In (c)S5T5, the charge is balanced (negative charge: positive charge=1:1) and the platelet adhesion occurs. In (d)S7T3 and (e)S10T0, only a few platelets are adhered and it indicates that (d)S7T3 and (e)S10T0 have the property of anti-platelet adhesion. The reason that there are still a few platelets adhered is because the hydrophobic cross linker that has no platelet adhesion resistance exists in the first polymer.

### Example 3

### Erythrocyte Adhesion Test for the First Polymer

The first polymer is prepared by the same way described in the example 1. The first polymer is dipped into a whole blood sample that is added with calcium ions. FIG. 10 shows laser scanning confocal microscopic images illustrating the erythrocyte adhesion test of the filter medium having different molar ratios of the negatively charged groups (S) to the positively charged groups (T) where (a)S0T10, (b)S3T7, (c)S5T5, (d)S7T3, and (e)S10T0. As shown in FIG. 10, when the first polymer is charge balanced (negative charge:positive charge=1:1), the first polymer shows very good anti-erythrocyte adhesion property. It is known that the surface of an erythrocyte is negatively charged and thus S0T10 and S3T7 adsorb a large number of erythrocytes as well as leukocytes (the large brightest points) due to electrostatic forces. For S7T3 and S10T0, only a small number of erythrocytes are adhered because there may be still a small amount of monomers on the surface.

### Example 4

### Leukocyte/Erythrocyte Separation Test

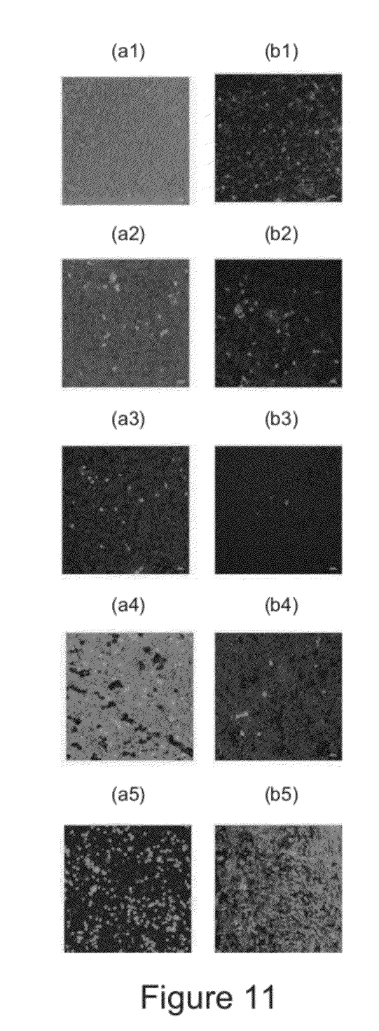

The purpose of performing the leukocyte/erythrocyte separation test is to differentiate the leukocyte/erythrocyte separation capability of different samples having different surface properties. The samples are prepared to have a surface being positive-charge rich, neutral, or negative-charge rich. The conditions for performing the leukocyte/erythrocyte separation test are as follows. Similar to the previous platelet adhesion test in example 2, the first polymer forms into a plurality of hydrogel disks. The hydrogel disks possess cross-linked structures. FIGS. 11-13 show laser scanning confocal microscopic images illustrating the whole blood adhesion tests of the filter media.

FIG. 11 shows the tests for the filter media with positive-charge rich surfaces. In FIG. 11, (a1)˜(a5) and (b1)˜(b5) show the tests for the whole blood without and with Ca²⁺ ions, respectively. In FIG. 11, (a1) and (b1) are tested for the filter medium with S: 0%/T: 100%; (a2) and (b2) are S: 10%/T: 90%; (a3) and (b3) are S: 20%/T: 80%; (a4) and (b4) are S: 30%/T: 70%; and (a5) and (b5) are S: 40%/T: 60%. FIG. 11(a1) shows serious hemolysis and FIG. 11(b1) shows complex blood cells are captured. FIGS. 11(a2), (b2), (b3), and (b3) show most of the erythrocytes are captured. FIGS. 11 (a4) and (b4) show both leukocytes and erythrocytes are captured and more leukocytes are captured in (a4). FIGS. 11 (a5) and (b5) show both leukocytes and erythrocytes are captured and more leukocytes are captured in (a5). From the above results of FIGS. 11 (a1)˜(a5) and (b1)˜(b5), a specific range for capturing leukocytes is shown.

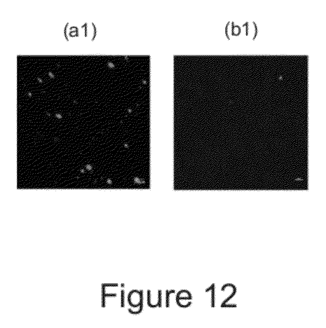

FIG. 12 shows the tests for the filter media with neutral surfaces. In FIG. 12, (a1) and (b1) show the tests for the whole blood without and with Ca²⁺ ions, respectively. FIG. 12(a1) shows only a few leukocytes are captured while FIG. 12(b1) shows almost no cell is captured.

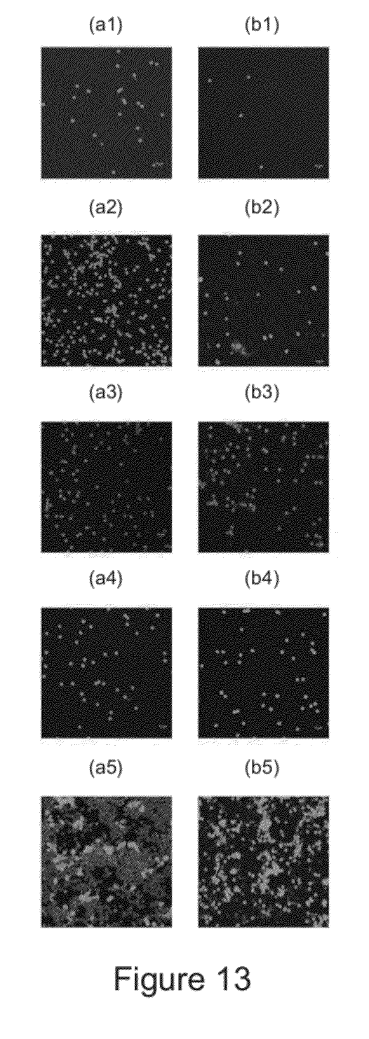

FIG. 13 shows the tests for the filter media with negative-charge rich surfaces. In FIG. 13, (a1)˜(a5) and (b1)˜(b5) show the tests for the whole blood without and with Ca²⁺ ions, respectively. In FIG. 13, (a1) and (b1) are tested for the filter medium with S: 100%/0/T: 0%; (a2) and (b2) are S: 90%/T: 10%; (a3) and (b3) are S: 80%/T: 20%; (a4) and (b4) are S:70%/T:30%; and (a5) and (b5) are S: 60%/T: 40%. FIGS. 13 (a1) and (b1), (a2), and (b2) show only erythrocytes are captured. FIGS. 13 (a3) and (b3) show only erythrocytes are captured and platelets are activated for the whole blood without Ca²⁺ ions. FIGS. 13 (a4) and (b4) show only erythrocytes are captured. FIGS. 13 (a5) and (b5) show both erythrocytes and leukocytes are captured and platelets are activated for the whole blood without Ca²⁺ ions. Therefore, the above results show that more than 90% of the leukocytes in the whole blood sample are removed and more than 90% of the erythrocytes in the whole blood sample are recovered.

In conclusion, the present invention discloses a filter medium for leukocyte removal, a method for manufacturing thereof, and a method for selectively removing leukocytes without causing blood coagulation. The charge distribution of the surface of the filter medium, the hydrophilic and hydrophobic characteristics of the surface of the filter medium, and the microstructures of the filter medium are utilized to achieve the purpose of filtering leukocytes without causing blood coagulation.

Obviously many modifications and variations are possible in light of the above teachings. It is therefore to be understood that within the scope of the appended claims the present invention can be practiced otherwise than as specifically described herein. Although specific embodiments have been illustrated and described herein, it is obvious to those skilled in the art that many modifications of the present invention may be made without departing from what is intended to be limited solely by the appended claims.

What is claimed is:

1. A filter medium for removing leukocytes from a leukocyte-containing sample, comprising:
a substrate; and
a first polymer, forming cross-linked networks or polymer brushes on the substrate and comprising charged groups or latent charged groups;
wherein the surface of the substrate formed with the first polymer possesses a specific charge distribution having charged domains and zwitterionic non-charged domains so that leukocytes are removed from the leukocyte-containing sample and the sample does not form clots when passing through the substrate.

2. The medium according to claim 1, wherein the first polymer comprises a plurality of positively charged groups and a plurality of negatively charged groups.

3. The medium according to claim 2, wherein the positively charged groups and the negatively charged groups are derived from (1) a compound comprising zwitterionic groups and a compound comprising positively charged groups, (2) a compound comprising zwitterionic groups and a compound comprising negatively charged groups, or (3) a compound comprising positively charged groups and a compound comprising negatively charged groups.

4. The medium according to claim 2, wherein, when the surface of the substrate formed with the first polymer is positively charged, the molar ratio of the positively charged groups to the negatively charged groups is between 50.5:49.5 and 70:30.

5. The medium according to claim 2, wherein, when the surface of the substrate formed with the first polymer is negatively charged, the molar ratio of the positively charged groups to the negatively charged groups is between 49.5:50.5 and 40:60.

6. The medium according to claim 2, wherein, when the surface of the substrate formed with the first polymer is charge balanced (uncharged), the substrate comprises a plurality of pores having an average pore diameter of 1˜8 μm.

7. The medium according to claim 3, wherein the zwitterionic groups are derived from the group consisting of the following: 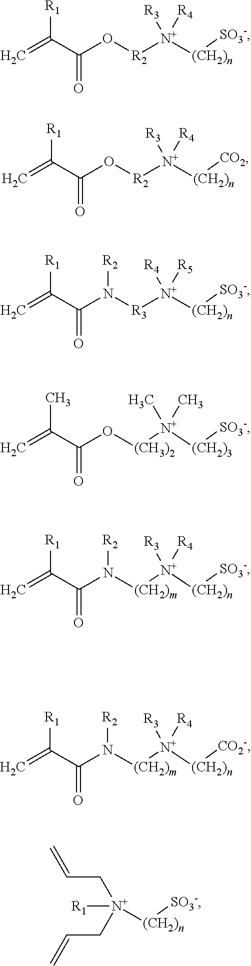
N-(2-aminoethyl)carbamoyl propanoic acid having the following general equation: 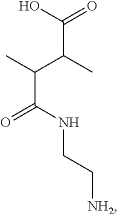
N-(3-aminopropyl)carbamoyl propanoic acid having the following general equation: 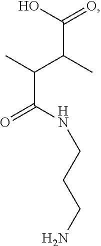
N—(N′,N′-dimethyl-2-aminoethyl)carbamoyl propanoic acid having the following general equation: 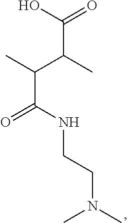
and N—(N′,N′-dimethyl-3-aminopropyl)carbamoyl propanoic acid having the following general equation: 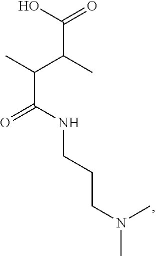
where R₁, R₂, R₃, R₄, and R₅ are alkyl groups and n, m are integers of 2˜5.

8. The medium according to claim 3, wherein the positively charged groups are derived from the group consisting of the following:

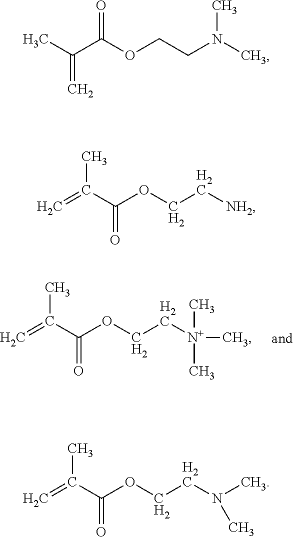

9. The medium according to claim 3, wherein the negatively charged groups are derived from the group consisting of the following:

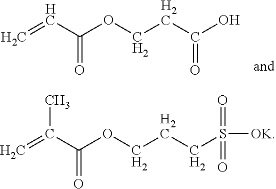

10. The medium according to claim 1, wherein the substrate is a membrane having a bi-continuous structure or a fibrous structure.

11. The medium according to claim 10, wherein the substrate is made of a second polymer selected from the group consisting of the following: Polypropylene (PP), polytetrafluoroethylene (PTFE), polystyrene (PS), polyethylene terephthalate (PET), polyester, polyvinylidene fluoride (PVDF), fluoropolymer, nowoven fiber, and polyurethane (PU).

12. The medium according to claim 10, wherein the substrate is a membrane having a bi-continuous structure and the pore diameter of the membrane is in a range of 1˜8 μm.

13. The medium according to claim 10, wherein the substrate is a membrane having a fibrous structure, the pore diameter of the membrane is in a range of 1˜8 μm, and the average fiber diameter is in a range of 1˜3 μm.

14. A method for selectively removing leukocytes from a leukocyte-containing sample, comprising:
providing a filter medium wherein the filter medium comprises a substrate and a first polymer formed on the substrate, the first polymer forms cross-linked networks or polymer brushes on the substrate and comprises charged groups or latent charged groups to control the electrical characteristic of the first polymer such that the surface of the substrate formed with the first polymer possesses a specific charge distribution having charged domains and zwitterionic non-charged domains; and
having the leukocyte-containing sample pass through the filter medium to obtain a filtered solution.

15. The method according to claim 14, wherein the method of removing leukocytes from the leukocyte-containing sample uses the specific charge distribution having charged domains and zwitterionic non-charged domains to filter leukocytes.

16. The method according to claim 14, wherein the first polymer comprises a plurality of positively charged groups and a plurality of negatively charged groups and the positively charged groups and the negatively charged groups are derived from (1) a compound comprising zwitterionic groups and a compound comprising positively charged groups, (2) a compound comprising zwitterionic groups and a compound comprising negatively charged groups, or (3) a compound comprising positively charged groups and a compound comprising negatively charged groups.

17. The method according to claim 16, wherein, when the surface of the substrate formed with the first polymer is positively charged, the molar ratio of the positively charged groups to the negatively charged groups is between 50.5:49.5 and 70:30.

18. The method according to claim 16, wherein, when the surface of the substrate formed with the first polymer is negatively charged, the molar ratio of the positively charged groups to the negatively charged groups is between 49.5:50.5 and 40:60.

19. The method according to claim 16, wherein, when the surface of the substrate formed with the first polymer is charge balanced (uncharged), the substrate comprises a plurality of pores having an average pore diameter of 1˜8 μm.

20. The method according to claim 16, wherein the zwitterionic groups are derived from the group consisting of the following: 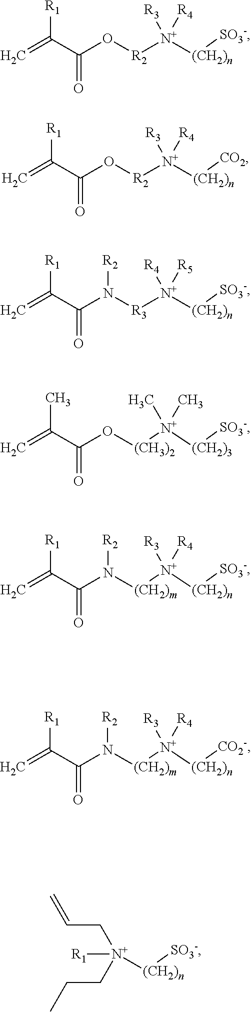
N-(2-aminoethyl)carbamoyl propanoic acid having the following general equation: 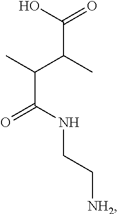
N-(3-aminopropyl)carbamoyl propanoic acid having the following general equation: 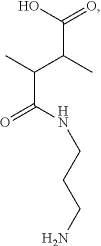
N—(N′,N′-dimethyl-2-aminoethyl)carbamoyl propanoic acid having the following general equation: 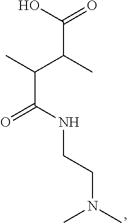
and N—(N′,N′-dimethyl-3-aminopropyl)carbamoyl propanoic acid having the following general equation: 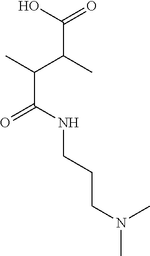
where R₁, R₂, R₃, R₄, and R₅ are alkyl groups and n, m are integers of 2˜5.

21. The method according to claim 16, wherein the positively charged groups are derived from the group consisting of the following:

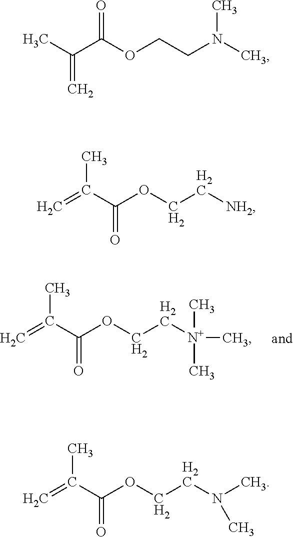

22. The method according to claim 16, wherein the negatively charged groups are derived from the group consisting of the following:

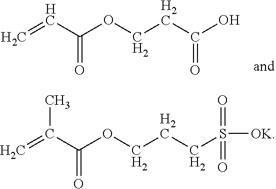

23. The method according to claim 14, wherein the substrate is a membrane having a bi-continuous structure or a fibrous structure.

24. The method according to claim 23, wherein the substrate is made of a second polymer selected from the group consisting of the following: Polypropylene (PP), polytetrafluoroethylene (PTFE), polystyrene (PS), polyethylene terephthalate (PET), polyester, polyvinylidene fluoride (PVDF), fluoropolymer, nowoven fiber, and polyurethane (PU).

25. The method according to claim 23, wherein the substrate is a membrane having a bi-continuous structure and the pore diameter of the membrane is in a range of 1˜8 μm.

26. The method according to claim 23, wherein the substrate is a membrane having a fibrous structure, the pore diameter of the membrane is in a range of 1˜8 μm, and the average fiber diameter is in a range of 1˜3 μm.

27. The method according to claim 16, wherein the specific charge distribution is determined by the allocation and the concentration of the charged groups or the latent charged groups.

28. A method for manufacturing a filter medium for removing leukocytes, comprising:
providing a substrate;
performing surface treatment to the substrate; and
forming a first polymer on the surface of the substrate by thermal induced radical polymerization or surface initiated atom transfer radical polymerization;
wherein the first polymer is formed by polymerization of a monomer containing zwitterionic groups and a monomer containing positively charged groups, polymerization of a monomer containing zwitterionic groups and a monomer containing negatively charged groups, or polymerization of a monomer containing positively charged groups and a monomer containing negatively charged groups.

29. The method according to claim 28, wherein the surface treatment is ozone exposure treatment or treatment including ozone exposure and bromide activation.

30. The method according to claim 28, wherein the zwitterionic groups are derived from the group consisting of the following: 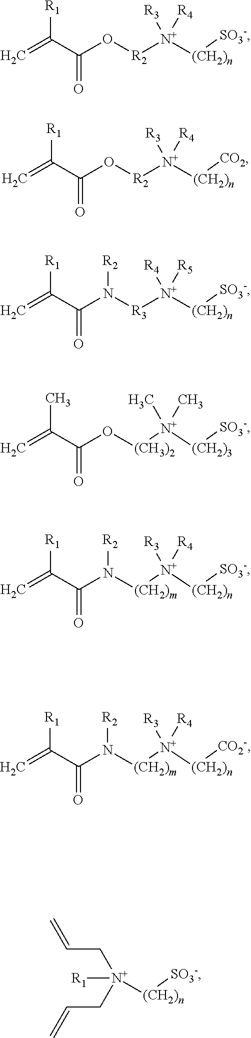
N-(2-aminoethyl)carbamoyl propanoic acid having the following general equation: 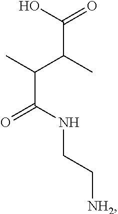
N-(3-aminopropyl)carbamoyl propanoic acid having the following general equation: 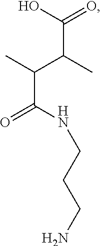
N—(N′,N′-dimethyl-2-aminoethyl)carbamoyl propanoic acid having the following general equation: 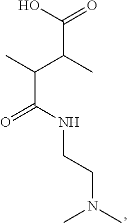
and N—(N′,N′-dimethyl-3-aminopropyl)carbamoyl propanoic acid having the following general equation: 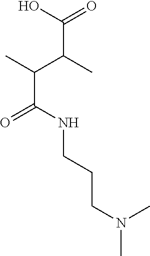
where R₁, R₂, R₃, R₄, and R₅ are alkyl groups and n, m are integers of 2˜5.

31. The method according to claim 28, wherein the positively charged groups are derived from the group consisting of the following:

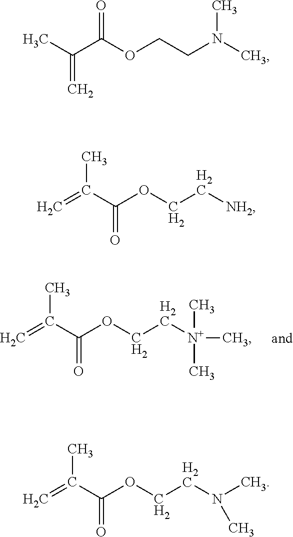

32. The method according to claim 28, wherein the negatively charged groups are derived from the group consisting of the following:

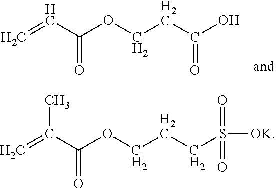

33. The method according to claim 14, wherein the substrate is a membrane having a bi-continuous structure or a fibrous structure and the substrate is made of a second polymer selected from the group consisting of the following: Polypropylene (PP), polytetrafluoroethylene (PTFE), polystyrene (PS), polyethylene terephthalate (PET), polyester, polyvinylidene fluoride (PVDF), fluoropolymer, nowoven fiber, and polyurethane (PU).

34. The method according to claim 28, wherein the substrate is a membrane having a bi-continuous structure and the pore diameter of the membrane is in a range of 1˜8 μm.

35. The method according to claim 28, wherein the substrate is a membrane having a fibrous structure, the pore diameter of the membrane is in a range of 1˜8 μm, and the average fiber diameter is in a range of 1˜3 μm.
